(19) United States
(12) Patent Application Publication
(10) Pub. No.: US 2003/0094190 A1
(43) Pub. Date: May 22, 2003

(54) Crutch

(76) Inventor: Daniel Lee, Hsi-Chih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/988,088

(22) Filed: Nov. 19, 2001

(51) Int. Cl. A45B 1/00; A45B 7/00; A45B 9/00; A45B 9/04; A61H 3/02

(52) U.S. Cl. 135/65; 135/68; 135/69; 135/72; 135/75; 135/77; 135/82

(57) ABSTRACT

An improved crutch consists of a crutch pad, a main tube, an auxiliary tube, a handgrip and an adjustment tube. The adjustment tube is coupled with the main tube through the bottom end of the main tube to form an integrated body therewith and are extensible and adjustable to a length desired to suit users' requirements. The auxiliary tube is fastened to one side of the main tube. The hand grip is bridged between the main tube and the auxiliary tube to form a firm and steady crutch.

### BACKGROUND OF THE INVENTION

1. Field of the Invention

The present invention relates to an improved crutch and particularly a crutch allows to adjust length easily and is constructed to save material consumption.

2. Description of the Prior Art

Crutch is an auxiliary walking tool to aid people handicapped in walking. A conventional crutch, like the one disclosed in ROC Patent No. 391253, entitled “Improved crutch” and shown in FIG. 4, has a center tube sandwiched between two side tubes, a crutch pad located at the top ends of the side tubes and a handgrip bridged the two side tubes in the middle section. The center tube has two arched side flanges located on two sides thereof. The side flange has two edges each forming a hook. The side tubes has respectively a groove formed on the tube wall matching and engageable with the hook. Once engaged, the center tube and side tubes may be fastened together through fasteners to result in a firm and steady construction.

The conventional crutch set forth above thus includes a center tube, two side tubes, a crutch pad, a handgrip and an extension tube coupled with the center tube (not mentioned in the description, but is shown in the drawings). The extension tube aims to adjust the total length of the crutch to suit people of different physical heights. As shown in FIG. 4, the element for adjusting the length of the crutch is located on the center tube which is sandwiched by the two side tubes. Thus the cross section of the adjusting element includes the cross section of the center tube and side tubes, and usually is too great for users to grasp with one hand. Hence users have to adjust the length of the crutch with two hands. It is not convenient.

Moreover, the construction requires the two side tubes overlapping with the center tube for a considerable length. As a result, it consumes more materials.

### SUMMARY OF THE INVENTION

In view of the foregoing disadvantages, the primary object of the invention is to provide an improved crutch that has a novel fastening structure to facilitate adjustment of the length of the crutch.

Another object of the invention is to decrease material consumption for reducing production costs.

To achieve the foregoing objects, the crutch of the invention has an adjustment tube directly coupled with a main tube through the bottom end of the main tube such that they become an integrated body, therefore users can make length adjustment with single hand to suit their requirements and material consumption can be reduced to save costs.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of the present invention;

FIG. 2 is an exploded view of the present invention;

FIG. 3A is a schematic view of the present invention in use for adjustment;

FIG. 3B is another schematic view of the present invention in use for adjustment; and,

FIG. 4 is a perspective view of a conventional crutch.

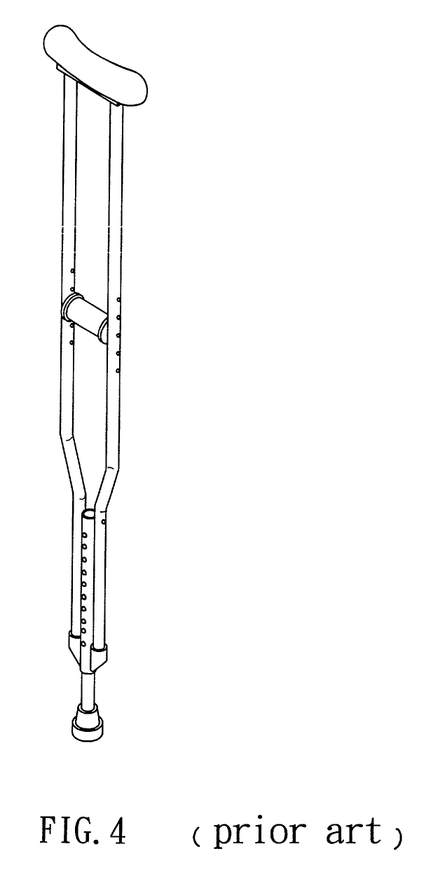

### DESCRIPTION OF THE PREFERRED EMBODIMENT

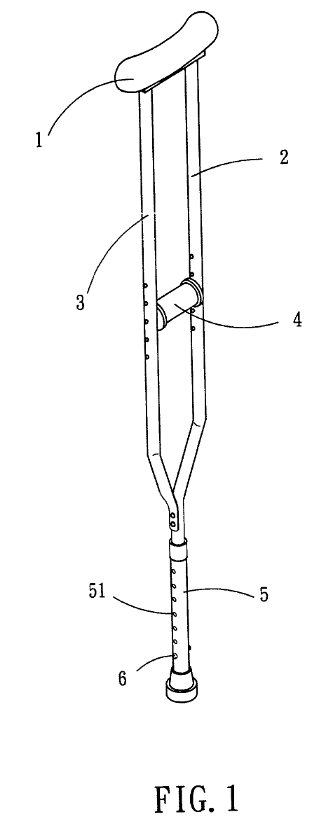

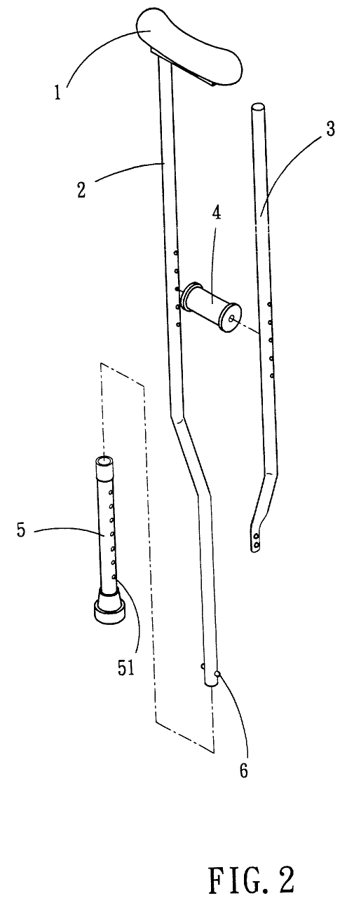

Referring to FIGS. 1 and 2, the crutch of the invention mainly consists of a crutch pad 1, a main tube 2, an auxiliary tube 3, a handgrip 4 and an adjustment tube 5. The adjustment tube 5 is coupled with the main tube 2 through the bottom end of the main tube 2 such that the adjustment tube 5 and the main tube 2 become an integrated body (forming an outer tube and an inner tube relationship), and are extensible for adjusting the length freely to a length desired to suit users' requirements. The main tube 2 has an anchor element 6 to control the coupling condition of the main tube 2 and adjustment tube 5. The anchor element 6 is located in the vicinity of the bottom end of the main tube 2. The adjustment tube 5 has a plurality of latch bores 51 engageable with the anchor element 6 for setting coupling position between the main tube 2 and adjustment tube 5.

In addition, the auxiliary tube 3 has a biased end fastened to an inner side below a biased section of the main tube 2, and a top end fastened to the bottom side of the crutch pad 1 as the top end of the man tube 2 does. The handgrip 4 is transversely bridged the main tube 2 and auxiliary tube 3 above the biased section to increase the steadiness of the crutch.

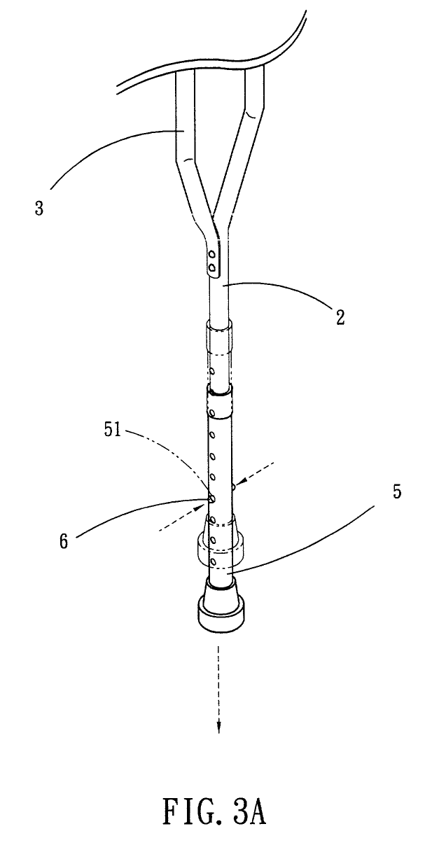

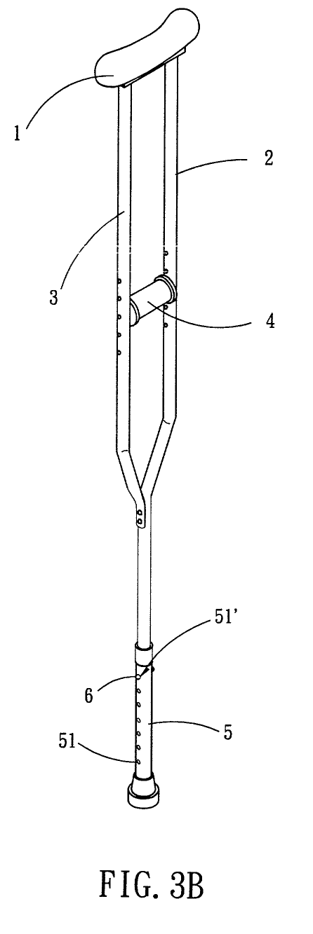

Referring to FIGS. 3A and 3B, by means of the construction set forth above, the adjustment tube 5 and the man tube 2 may be coupled as an integrated body to save material consumption and assembly time, also to reduce production costs, and become more convenient to use. When users use the crutch at the initial period and have to adjust the length of the crutch to suit their physical heights, the cross section of the man tube 2 and adjustment tube 5 where the anchor element is located is preferably no greater than the size of the adjustment tube 5 so that users can make adjustment conveniently with single hand to save efforts.

To make adjustment, users grasp the adjustment tube 5 proximate the anchor element 6 and push the anchor element 6 away from the latch bore 51, then pull (or push) the adjustment tube 5 to slide relative to the main tube 2 to adjust the extended length of the main tube 2 and adjustment tube 5 until reaching the length desired and suiting users' physical height. Then select a latch bore 51′ at the nearest location and latch the anchor element 6 into the latch bore 51′ to anchor the adjustment tube 5 on the main tube 2 so that they are fastened together without slipping relative to each other. The adjustment can be done simply and conveniently without much efforts.

While the preferred embodiment of the present invention has been set forth for the purpose of disclosure, modifications of the disclosed embodiment of the present invention as well as other embodiments thereof may occur to those skilled in the art. Accordingly, the appended claims are intended to cover all embodiments which do not depart from the spirit and scope of the present invention.

What is claimed is:

1. An improved crutch comprising a crutch pad, a main tube, an auxiliary tube, a handgrip and an adjustment tube; wherein the auxiliary tube is fastened to one side of the main tube, the adjustment tube being coupled with the main tube through the bottom end of the main tube to form an integrated body therewith and being extensible and adjustable to a length desired to suit users' requirements.

2. The improved crutch of claim 1, wherein the main tube and the auxiliary tube are fixedly fastened to the crutch pad, the hand grip being bridged between the main tube and the auxiliary tube.

3. The improved crutch of claim 1, wherein the main tube has an anchor element for controlling the extensible length of the main tube and the adjustment tube.

4. The improved crutch of claim 3, wherein the adjustment tube has a plurality of latch bores to engage with the anchor element.
